(19) United States
(12) Patent Application Publication
(10) Pub. No.: US 2002/0100265 A1
(43) Pub. Date: Aug. 1, 2002

(54) Solar-electric powered lawnmower with electronic minimization of energy consumption

(76) Inventors: Samson Mil'shtein, Chelmsford, MA (US); William A. Teynor, Somerville, MA (US); Bradley Leo Paquin, Dracut, MA (US); Timothy A. Deloge, Dracut, MA (US); Yan K. Tran, Dracut, MA (US); Rebecca Brady Snoonian, Los Angeles, CA (US)

Correspondence Address: Samson Mil'shtein, 6 Warwick Dr., Chelmsford, MA, 01824, US

(21) Appl. No.: 09/783,454

(22) Filed: Feb. 14, 2001

Related U.S. Application Data
(60) Provisional application No. 60/185,082, filed on Feb. 25, 2000.

(51) Int. Cl. A01D 69/02

(52) U.S. Cl. 56/11.9

(57) ABSTRACT

The invention describes a solar-electric lawn mower. The ergonomic operation of the mower is provided by a controller to minimize the current consumed. Change of grass density or any other change of a load to the blade is sensed by a controller and fed-back to the circuitry. Solar cells could be mounted on a mower and provide partial recharging of the batteries during grass cutting or recharge the batteries on a resting mower. Clean energy, low noise, no pollution, no energy cost, safe operation and low maintenance should be added as benefits to the estimated cost of the prototype.

### BACKGROUND OF THE INVENTION

In the lawn mowing equipment, there are two basic groups of machines: gasoline powered and electric powered. Both groups carry their own drawbacks. The gasoline unit is rather polluting, noisy, not ergornomical from an energy standpoint. The electrical mower is difficult to operate due to the lengthy cord used, which reduces significantly the maneuverability of a lawn mower.

Recently, a hypothetical design of solar powered lawnmower was patented (U.S. Pat. No. 4,942,723 of Jul. 24, 1990). To list the disadvantages of this patent, one should mention that no technical description is presented. Even the conceptual drawings are presenting a rather bulky, non-operational machine. A question to whether or not this machine provides enough energy to operate remains unanswered. It is clear that the major element of any solar powered machine is the compatibility of the equipment to the limited energy generation by solar cells. Not answering this question, the mentioned patent offers very little in the description of the machine.

Contrary to the three types of equipment mentioned, our invention uses clean energy and is an environmentally friendly machine. Our equipment carries a great deal of autonomy in operation (no electrical cord), does not require replacement of parts such as oil filters, etc. in maintenance, does not require steady supply of fuel. The major difference of our invention from the above is electronic minimization of energy consumption.

### DESCRIPTION OF THE INVENTION

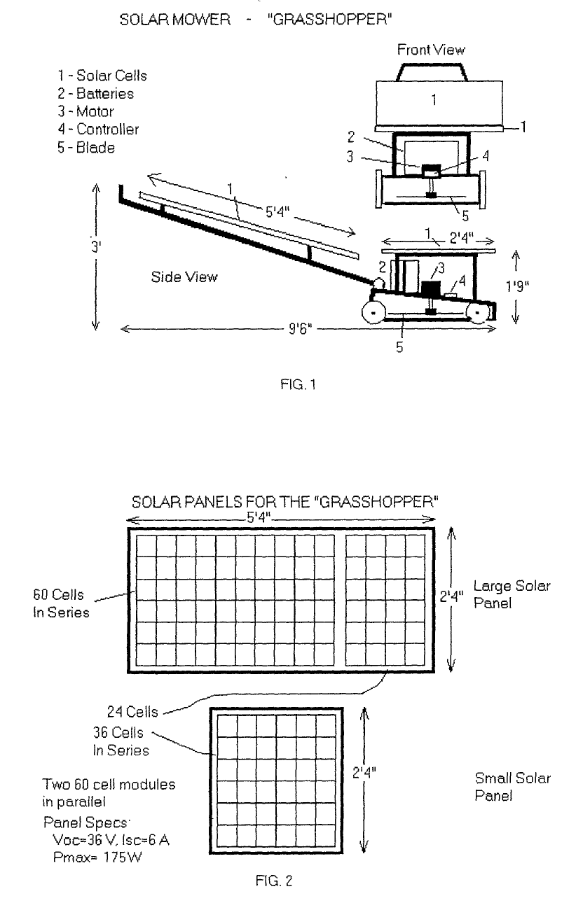

We designed a new lawnmower where the limited generation of power by solar cells was compensated by minimizing the energy needed for the operation of the prototype (see FIGS. 1,3). Significant benefits of our invention vs. gasoline powered lawnmower or wire connected electrical mower are based on the following elements of the design:

a) Threshold automatic control of the current.

b) The DC motor is selected to provide the highest efficiency (81-84%) at low as possible current through the motor.

c) Batteries were selected to provide high energy density (30 W-hr/kg).

d) Conventional solar cells (14% efficient) were used in the design. The selection of all the components was driven by cost.

We designed and tested a machine that is operating with a conventional lawn blade using 320 watts (approx. 0.43 hp) and on dense grass, peaking to about 746 watts (approx. 1 hp). The solar cells are able to produce 175 watts under conventional one sun condition. The machine requires 24 volts and about 10 amperes while solar cells produce about 6 amperes. The mower is fully operational for 2 hours using batteries and 3 hours in case combined batteries and solar cell are used. Batteries are completely recharged in a day by the solar panels.

| MATERIAL | COST |
|---|---|
| Solar Cells | $400 |
| Motor | 150 |
| Batteries | 100 |
| Controller | 70 |
| Body | 30 |
| Total: | $750 |

Comparing this cost with commercially available gasoline engine lawn mower, we see that due to the cost of solar cells, the proposed machine is more expensive. With that, we list the benefits of our invention as follows:

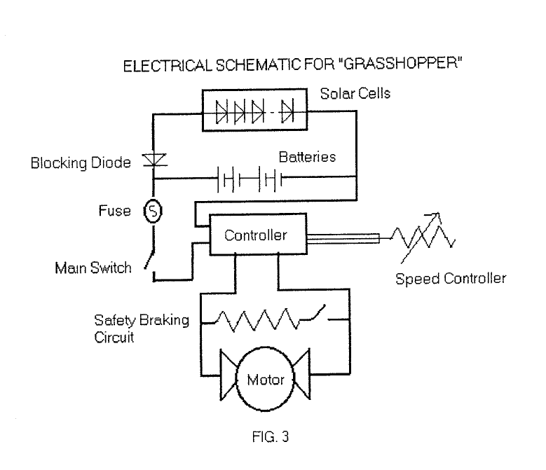

a) With the well known limitation of energy produced by the sun per square meter, we succeeded to design a very efficient machine (see FIG. 2) which will perform the task

b) Use of clean energy makes this machine environmentally friendly

c) The level of noise is minimized

d) Safe and simple operation of the machine

e) Reduced cost of maintenance and zero cost for energy

The name of our machine has been dubbed, THE GRASSHOPPEIR This name is used below replacing lengthy name depicted in the title of our invention.

1. We designed the Grasshopper so that the current needed to operate an electric motor is minimized proportionally to the load, for example, changing density of grass.

2. According to claim 1 the autonomy of lawnmower operation is provided by set of batteries. Mounted on the top of the mower in two sections are the solar cells.

3. According to claims 1 and 2, the flexibility of mounting of solar cells allow to keep solar cell on a lawnmower during grass cutting for bigger lawns or to remove them from the lawnmower if the energy stored in the batteries is sufficient for the grass cutting job.

4. According to claims 2 and 3 charging of the batteries could be performed during and/or after lawn mowing.

5. According to claims 1-4, the direction of a blade rotation could be changed by an electrical switch. That allows to change the direction of grass throwing (no bag mower) i.e. make the mower much more maneuverable.

6. According to claims 1-4, the design of the system allows to use motors with various efficiency, the batteries with higher energy density, and solar cells with higher than 14%, which were used in a prototype.

7. According to claims 1-4, the safety is provided by using low voltage in operation, charging and maintenance of the lawn mower.

8. According to claims 1-4, the hazardous noise level is reduced to 1-2 dB, which could be compared with a noise produced by a conventional desk fan.

9. According to claims 1-5, the lawnmower operates with zero cost for energy and reduced cost for maintenance.
